(19) United States
(12) Patent Application Publication
(10) Pub. No.: US 2024/0133051 A1
(43) Pub. Date: Apr. 25, 2024

(54) Systems and Methods for Electrochemical Hydrogen Looping

(71) Applicants: California Institute of Technology, Pasadena, CA (US); The Regents of the University of California, Oakland, CA (US)

(72) Inventors: Harry A. Atwater, South Pasadena, CA (US); Zachary Schiffer, Pasadena, CA (US); Chengxiang Xiang, San Marino, CA (US); Shane Ardo, Irvine, CA (US)

(73) Assignees: California Institute of Technology, Pasadena, CA (US); The Regents of the University of California, Oakland, CA (US)

(21) Appl. No.: 18/484,332

(22) Filed: Oct. 10, 2023

Related U.S. Application Data
(60) Provisional application No. 63/414,765, filed on Oct. 10, 2022.
(60) Provisional application No. 63/530,012, filed on Jul. 31, 2023.

(51) Int. Cl. C25B 1/04; C02F 1/461; C25B 9/65; C25B 11/032; C25B 15/031; C25B 15/08

(52) U.S. Cl. CPC C25B 1/04; C02F 1/46109; C02F 1/4618; C25B 9/65; C25B 11/032; C25B 15/031; C25B 15/085; C02F 2103/08

(57) ABSTRACT

Systems and methods for electrochemical hydrogen looping cells are described. Generating a pH swing can expedite carbon dioxide capture from oceanwater. Many embodiments implement electrochemical hydrogen looping cells that simultaneously produce acid via anodic hydrogen oxidation and base via cathodic hydrogen evolution to generate a pH change.

### CROSS-REFERENCE TO RELATED APPLICATIONS

The current application claims the benefit of and priority under 35 U.S.C. § 119 (e) to U.S. Provisional Patent Application No. 63/414,765 entitled “Electrochemical Hydrogen Looping For Acid and Base Generation” filed Oct. 10, 2022, and to U.S. Provisional Patent Application No. 63/530,012 entitled “Electrochemical Hydrogen Looping For Acid and Base Generation” filed Jul. 31, 2023. The disclosures of U.S. Provisional Patent Application Nos. 63/414,765 and 63/530,012 are hereby incorporated by reference in their entirety for all purposes.

### GOVERNMENT SPONSORED RESEARCH

This invention was made with government support under Grant No. DE-AR0001407 awarded by the Department of Energy. The government has certain rights in the invention.

### FIELD OF THE INVENTION

The present invention generally relates to systems and methods for electrochemical hydrogen looping for acid and base generation; and more particularly to systems and methods for electrochemical hydrogen looping for acid and base generation for carbon capture.

### BACKGROUND OF THE INVENTION

The hydrogen oxidation reaction (HOR) and the hydrogen evolution reaction (HER) are a pair of reversible reactions: H₂(g)⇄2H⁺(aq)+2e⁻(s) (g stands for gas, aq stands for aqueous, and s stands for solid). The HOR and HER are important processes in renewable energy conversion and storage devices, such as fuel cells and electrolyzers.

Direct ocean capture (DOC) is a carbon capture strategy that can leverage the fact that the solvation equilibrium between gaseous and aqueous CO₂ results in atmospheric CO₂ being concentrated in the oceans. The oceans act as a large sink for atmospheric CO₂ because aqueous CO₂ undergoes further reactivity with water to form a bicarbonate buffer. As a result of this buffer, the concentration of dissolved inorganic carbon in the oceans is more than 100 times larger than the concentration of carbon dioxide in the atmosphere, making the oceans an attractive target for carbon removal. The rate of removal of carbon dioxide from the oceans depends strongly on the pH, which is a measure of acidity, implying that a pH swing can increase rates of carbon capture from a gas phase or carbon release to a gas phase.

### BRIEF SUMMARY OF THE INVENTION

Many embodiments are directed to systems of electrochemical hydrogen looping and associated methods thereof.

Some embodiments include an electrochemical system comprising: a cathode with a first side contacting a cathode gas chamber and a second side contacting a catholyte; and an anode with a first side contacting an anode gas chamber and a second side contacting an anolyte, wherein the catholyte and the anolyte are separated by a separator; wherein the cathode is configured to catalyze a hydrogen evolution reaction and produce hydrogen gas and a basic stream with a pH less than or equal to 13 and greater than or equal to 7, and the anode is configured to catalyze a hydrogen oxidation reaction and produce an acidic stream with a pH greater than or equal to 1 and less than or equal to 7; and wherein the cathode gas chamber connects with the anode gas chamber via a flow channel such that the hydrogen gas flows from the anode to the cathode.

In some embodiments, the cathode and the anode each comprises a gas diffusion electrode that separates a gas phase and a liquid phase.

In some embodiments, the second side of the cathode and the second side of the anode each comprises a layer configured to be a barrier to prevent a gas phase and a liquid phase from mixing; wherein the layer is selected from the group consisting of: a polymer layer, a ceramic layer, a layer with a positive electrical charge, and a layer with a negative electrical charge.

In some embodiments, the layer comprises an ionomer selected from the group consisting of a Nafion® ionomer, a Nafion® D520 ionomer, a Sustainion® ionomer, and a Versogen® PiperION-A5 ionomer.

In some embodiments, the layer prevents buildup of precipitates on the electrodes when performing polarity switch to the cathode and the anode.

In some embodiments, the layer prevents bubble formation on the cathode and the anode.

Some embodiments further comprise current collectors connected to the cathode and the anode for connecting the cathode and the anode to an external circuit.

In some embodiments, the catholyte and the anolyte comprise sodium ions and chloride ions.

In some embodiments, ionic concentrations of the catholyte and the anolyte are higher than proton and hydroxide ion concentrations such that neutralization of the acidic and basic streams is minimized.

In some embodiments, the separator comprises a filter paper, a qualitative grade filter paper, a quantitative grade filter paper, a glass fiber filter, a quartz fiber filter, a chromatography filter paper, a coffee filter paper, a tea filter paper, a ceramic membrane, or a sodium superionic conductor membrane.

In some embodiments, the system is configured to achieve a current density less than or equal to 500 mA/cm².

In some embodiments, the system has a configuration selected from the group consisting of: an H cell, a cell stack, a flow cell, and a flow stack.

In some embodiments, the basic stream has a pH greater than 12 and the acidic stream has a pH less than 2.

In some embodiments, the acidic stream and the basic stream are collected for direct carbon capture.

In some embodiments, the system has a Coulombic efficiency of at least 80%.

Some embodiments include a system for direct ocean capture, comprising: an input configured to receive a source oceanwater; an electrochemical system configured to receive a first portion of the source oceanwater as an electrolyte; wherein the electrochemical system comprises: a cathode with a first side contacting a cathode gas chamber and a second side contacting a catholyte; and an anode with a first side contacting an anode gas chamber and a second side contacting an anolyte; wherein the catholyte and the anolyte are configured to receive the electrolyte and are separated by a separator; wherein the cathode is configured to catalyze a hydrogen evolution reaction and produce hydrogen gas and a basic stream with a pH less than or equal to 13 and greater than or equal to 7, and the anode is configured to catalyze a hydrogen oxidation reaction and produce an acidic stream with a pH greater than or equal to 1 and less than or equal to 7; and wherein the cathode gas chamber connects with the anode gas chamber via a flow channel such that the hydrogen gas flows from the anode to the cathode; a carbon dioxide stripping system configured to receive acidified oceanwater comprising a second portion of the source oceanwater and the acidic stream; wherein the carbon dioxide stripping system is configured to separate gaseous carbon dioxide and produce a decarbonized oceanwater stream; wherein the decarbonized oceanwater stream is configured to combine with the basic stream before being returned to the ocean.

In some embodiments, the cathode and the anode each comprises a gas diffusion electrode that separates a gas phase and a liquid phase.

In some embodiments, the second side of the cathode and the second side of the anode each comprises a layer configured to be a barrier to prevent a gas phase and a liquid phase from mixing; wherein the layer is selected from the group consisting of: a polymer layer, a ceramic layer, a layer with a positive electrical charge, and a layer with a negative electrical charge.

In some embodiments, the layer comprises an ionomer selected from the group consisting of a Nafion® ionomer, a Nafion® D520 ionomer, a Sustainion® ionomer, and a Versogen® PiperION-A5 ionomer.

In some embodiments, the layer prevents buildup of precipitates on the electrodes when performing polarity switch to the cathode and the anode.

In some embodiments, the layer prevents bubble formation on the cathode and the anode.

In some embodiments, the electrochemical system further comprises current collectors connected to the cathode and the anode for connecting the cathode and the anode to an external circuit.

In some embodiments, an ionic concentration of the electrolyte is higher than proton and hydroxide ion concentrations such that neutralization of the acidic and basic streams is minimized.

In some embodiments, the separator comprises a filter paper, a qualitative grade filter paper, a quantitative grade filter paper, a glass fiber filter, a quartz fiber filter, a chromatography filter paper, a coffee filter paper, a tea filter paper, a ceramic membrane, or a sodium superionic conductor membrane.

In some embodiments, the electrochemical system is configured to achieve a current density less than or equal to 500 mA/cm².

In some embodiments, the electrochemical system has a configuration selected from the group consisting of: an H cell, a cell stack, a flow cell, and a flow stack.

In some embodiments, the basic stream has a pH greater than 12 and the acidic stream has a pH less than 2.

In some embodiments, the electrochemical system has a Coulombic efficiency of at least 80%.

Some embodiments include a method for generating acidic and basic streams, comprising: applying a voltage to a cathode and an anode; wherein a first side of the cathode connects with a cathode gas chamber, and a second side of the cathode connects with a catholyte; wherein the cathode is configured to catalyze a hydrogen evolution reaction and produce hydrogen gas and a basic stream with a pH less than or equal to 13 and greater than or equal to 7; wherein a first side of the anode connects with an anode gas chamber, and a second side of the anode connects with an anolyte; wherein the anode is configured to catalyze a hydrogen oxidation reaction and produce an acidic stream with a pH greater than or equal to 1 and less than or equal to 7; wherein the catholyte and the anolyte are separated by a separator; wherein the cathode gas chamber connects with the anode gas chamber via a flow channel such that the hydrogen gas flows from the anode to the cathode; collecting the acidic stream and the basic stream.

In some embodiments, the cathode and the anode each comprises a gas diffusion electrode that separates a gas phase and a liquid phase.

In some embodiments, the second side of the cathode and the second side of the anode each comprises a layer configured to be a barrier to prevent a gas phase and a liquid phase from mixing; wherein the layer is selected from the group consisting of: a polymer layer, a ceramic layer, a layer with a positive electrical charge, and a layer with a negative electrical charge.

In some embodiments, the layer comprises an ionomer selected from the group consisting of a Nafion® ionomer, a Nafion® D520 ionomer, a Sustainion® ionomer, and a Versogen® PiperION-A5 ionomer.

In some embodiments, the layer prevents bubble formation on the cathode and the anode.

In some embodiments, the catholyte and the anolyte comprise sodium ions and chloride ions.

In some embodiments, ionic concentrations of the catholyte and the anolyte are higher than proton and hydroxide ion concentrations such that neutralization of the acidic and basic streams is minimized.

In some embodiments, the separator comprises a filter paper, a qualitative grade filter paper, a quantitative grade filter paper, a glass fiber filter, a quartz fiber filter, a chromatography filter paper, a coffee filter paper, a tea filter paper, a ceramic membrane, or a sodium superionic conductor membrane.

In some embodiments, the basic stream has a pH greater than 12 and the acidic stream has a pH less than 2.

In some embodiments, the acidic stream and the basic stream are collected for direct carbon capture.

Some embodiments further comprise switching a polarity of the voltage at a frequency to prevent buildup of precipitates on the cathode and the anode.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a schematic of carbon dioxide dissolved in the ocean.

FIG. 2 illustrates a schematic of a direct ocean carbon capture system.

FIG. 3 illustrates a schematic of a hydrogen looping cell in accordance with an embodiment.

FIG. 4A illustrates a schematic of a 3D printed endplate of a hydrogen looping cell in accordance of an embodiment.

FIG. 4B illustrates a disassembled view of a hydrogen looping cell in accordance of an embodiment.

FIG. 5A illustrates current density and potential under different gas flows at the anode in accordance with an embodiment.

FIG. 5B illustrates open circuit potential of an electrochemical cell when different gases are present at the cathode and the anode in accordance with an embodiment.

FIG. 6A illustrates a mass flow meter connected at the outlet of a hydrogen looping system in accordance with an embodiment.

FIG. 6B illustrates the change in hydrogen flow when a current is applied versus no current applied in accordance with an embodiment.

FIG. 7 illustrates variation in flow meter readings over time during quantification of hydrogen gas looping in accordance with an embodiment.

FIGS. 8A through 8D illustrate plots of Equation 5 in accordance with an embodiment of the invention.

FIGS. 9A through 9D illustrate electrochemical characterization of the hydrogen looping system in accordance with an embodiment.

FIGS. 10A and 10B illustrate galvanostatic staircase data for a cell without polymer coating on the electrodes in accordance with an embodiment.

FIG. 11 illustrates chronopotentiometry data at various current densities without polymer coating on the electrodes in accordance with an embodiment.

FIG. 12 illustrates measured resistance before and after each galvanostatic step in accordance with an embodiment.

FIGS. 13A through 13D illustrate COMSOL Multiphysics modelling of the hydrogen looping cell in accordance with an embodiment.

FIG. 14 illustrates COMSOL Multiphysics pH maps at various flowrates in accordance with an embodiment.

FIG. 15 illustrates pH lines at the outlet of the cell at various flowrates based on COMSOL Multiphysics simulation in accordance with an embodiment.

FIG. 16 illustrates breakdown of voltage drops across the cell based on COMSOL Multiphysics simulation in accordance with an embodiment.

FIGS. 17A through 17D illustrate the influence of polarity switching using simulated oceanwater as a liquid electrolyte in accordance with an embodiment.

FIGS. 18A and 18B illustrate voltage increase in hydrogen looping cell test with polarity switching in accordance with an embodiment.

FIGS. 19A through 19D illustrate post-electrolysis SEM images of electrodes in accordance with an embodiment.

FIG. 20 illustrates EDS results from electrodes in accordance with an embodiment.

FIG. 21 illustrates EDS point mapping of crystals in accordance with an embodiment.

### DETAILED DESCRIPTION OF THE INVENTION

Turning now to the drawings, electrochemical hydrogen looping systems for generating acid and base are described. The hydrogen looping systems can generate acid and base streams by oxidizing hydrogen to aqueous protons, or proton equivalents such as protonated buffers, at the anode (generating acid) and reducing aqueous protons, or proton equivalents, to hydrogen gas at the cathode (generating base). Because hydrogen gas is produced at the cathode and consumed at the anode, the byproducts of the system are the desired acid and base streams. The fast kinetics for HOR and HER can ensure energy efficient generation of acid and base for carbon capture. In various embodiments, the systems can achieve current densities of equal to or less than about 500 mA/cm² during electrochemical generation of acid and base. In several embodiments, the systems implement physical separators to separate the acid and base streams such that ion-exchange membranes can be eliminated. Neutralization of acid and base streams due to crossover through the physical separators can be minimized by increasing the concentrations of the electrolyte ions (such as sodium and chloride ions) to be higher than protons and hydroxides. The increase of sodium and chloride ions can occur naturally or artificially in the electrolytes. Several embodiments use oceanwater as electrolyte such that the concentrations of sodium and chloride ions are naturally higher than protons and hydroxides. Many embodiments artificially change the ion concentrations in the electrolyte to the desired concentrations.

Carbon capture processes in accordance with many embodiments can capture any dissolved inorganic carbon in a water source including (but not limited to): ocean, river, lake, reservoir, brackish water, desalinated water, synthetic oceanwater, and oceanwater mimics. Water source can be pretreated with acidic and/or alkaline solutions, or can be used without pre-treatment. Examples of dissolved inorganic carbon include (but are not limited to): aqueous carbon dioxide, bicarbonate, carbonate, carbonic acid, minerals, and sediments.

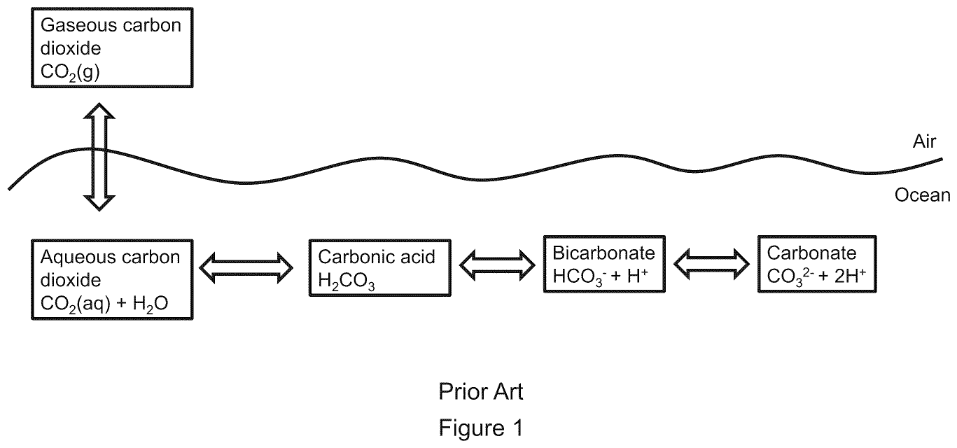

Oceans contain more carbon in the form of dissolved inorganic carbon than carbon dioxide (CO₂) (carbon dioxide and CO₂ are used interchangeably in this disclosure) in the atmosphere. The ocean is the largest inorganic carbon reservoir in exchange with atmospheric CO₂ and as a result, the ocean exerts a dominant control on atmospheric CO₂ levels. Dissolved carbon dioxide in the ocean occurs mainly in three inorganic forms: free aqueous carbon dioxide (CO₂(aq)), bicarbonate (HCO₃⁻(aq)), and carbonate ion (CO₃²⁻(aq)). The majority of dissolved inorganic carbon in the ocean is in the form of HCO₃⁻. FIG. 1 illustrates a schematic of dissolved inorganic carbon in the ocean. When CO₂ gas dissolves in the ocean, it interacts with the water to produce a number of different compounds according to Equation 1 and 2:

CO₂(g)+H₂O( [symbol] ) [symbol] HCO₃⁻+H⁺ (1)

HCO₃⁻ [symbol] CO₃²⁻+H⁺ (2)

CO₂ reacts with water to produce carbonic acid (H₂CO₃), which then dissociates into bicarbonate (HCO₃⁻) and hydrogen ions (H⁺). Bicarbonate can further dissociate into carbonate (CO₃²⁻) and an additional H⁺.

One method for direct ocean capture through electrodialysis is to drive the CO₂— bicarbonate equilibrium or balance toward dissolved CO₂ by acidifying the oceanwater. Acid can be added to a volume of oceanwater. The addition of acid can decrease the pH and shift the bicarbonate buffer equilibrium toward aqueous dissolved carbon dioxide (Equation 1 and 2). The aqueous dissolved carbon dioxide can be extracted and stored (such as, to be pumped underground, or transformed into more valuable chemicals, e.g., liquid fuels). Upon CO₂ removal, base can be added to the processed oceanwater to neutralize the acid before returning the water back to the ocean. The concentration of sequestered CO₂ in oceanwater is larger than in air because the ocean acts as a large bicarbonate buffer (Equation 1 and 2), where the carbon dioxide reacts with water to form bicarbonate and carbonate anions.

Gaseous carbon dioxide, CO₂(g), in the air exists in equilibrium with dissolved carbon dioxide, CO₂(aq), in the ocean. With the presence of significant cations in the ocean, the formation of bicarbonate and carbonate ions can lead to larger concentrations of carbon in the ocean relative to air. The relative concentrations of these ions and dissolved carbon dioxide are strongly influenced by the pH, with most of the dissolved inorganic carbon (DIC) existing as bicarbonate ions at ambient ocean pH values (pH of about 8.1). By acidifying oceanwater to an acidic pH (pH less than or equal to about 4), the equilibrium can be shifted such that DIC is primarily in the form of dissolved carbon dioxide, which can be separated from the oceanwater by various means such as (but not limited to) gas stripping in a gas-liquid contactor. (See, e.g., U.S. Patent Publication No. 2023-0107163 filed Sep. 20, 2022, the disclosure of which is incorporated by reference.) Various methods such as using water reduction/oxidation, proton reduction/hydrogen oxidation, and Bi/AgCl redox reactions to generate pH swings and acidify oceanwater so that the gaseous carbon dioxide is evolved. However, these methods can be limited to low current densities (for example, lower than about 10 mA/cm²). The low current density operation of the electrochemical cells can increase the capital expenditure of the carbon removal system by requiring that more cells be used for a target total carbon capture rate. Additionally, while a pH swing is an attractive method for evolving carbon dioxide gas from oceanwater, pumping significant volumes of oceanwater through an electrochemical device may be impractical and expensive. Isolated acid generation systems can be used to produce acidified water independently. The acid generation step can be isolated from the ocean acidification step such that relatively concentrated acid can be produced independently and added into the primary oceanwater input feed. Because a small amount of concentrated acid is needed to swing the pH of the intake oceanwater to pH lower than or equal to about 4, a tiny fraction of the total intake oceanwater needs to flow through the electrochemical cell. The efficiency of ocean carbon capture via a pH swing process can be greatly affected by the efficiency of generating acid and base streams from oceanwater.

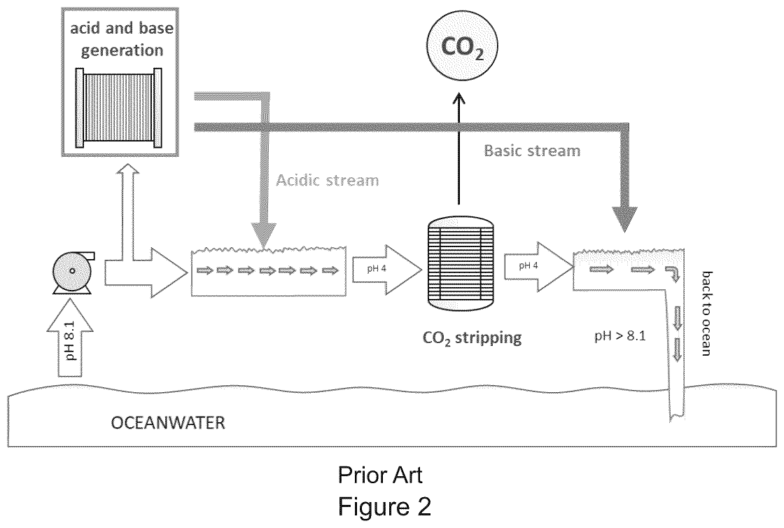

FIG. 2 illustrates a schematic of a direct ocean carbon capture system. Input oceanwater can be pumped into the capture system. A fraction of the input oceanwater can be diverted for acid and base generation. The generated acidic stream can be mixed in with the oceanwater to bring the pH of the oceanwater from about 8.1 to about 4. The acidic oceanwater can be used for carbon dioxide stripping. Gaseous carbon dioxide can be collected from the stripping process. The oceanwater with less dissolved carbon dioxide can be reconstituted with a basic stream from the acid and base generation process to bring the pH to greater than about 8.1 and to be returned back to the oceans.

Common acid and base to generate from oceanwater are hydrochloric acid and sodium hydroxide, as sodium chloride is a major component in oceanwater. Hydrochloric acid and sodium hydroxide can be industrially manufactured from sodium chloride. However, this industrial manufacturing process involves multiple steps, and generates chlorine and hydrogen gas as intermediate products. The industrial manufacturing process of hydrochloric acid and sodium hydroxide generally does not use oceanwater as a feed material and does not use a single and integrated system. Therefore, directly converting oceanwater into a concentrated hydrochloric acid stream and a concentrated sodium hydroxide stream would be more efficient and modular for direct ocean capture of carbon dioxide. Moreover, using oceanwater as input is tolerant to the presence of ocean salts. The hydrochloric acid and sodium hydroxide base streams that are contaminated by ocean salts, e.g., sodium chloride, are permissible.

Bipolar membrane electrodialysis can be used for producing concentrated acid and base streams from sodium chloride, which facilitates heterolytic dissociation of water into protons and hydroxides and also serves as a barrier to mitigate crossover of acid and base. (See, e.g., U.S. patent application Ser. No. 18/343,597 filed Jun. 28, 2023, the disclosure of which is incorporated by reference.) Bipolar membranes can be used for water electrolysis and hydrogen fuel cells, as well as for acid and base production. However, these membranes can be expensive and may not be stable for long durations under working conditions.

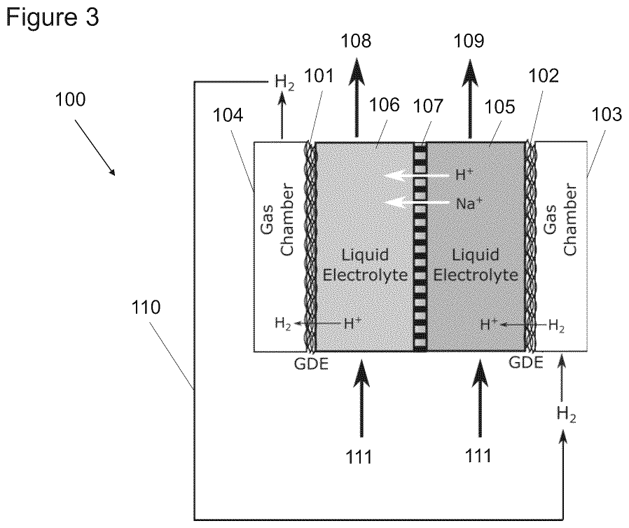

Many embodiments implement electrochemical hydrogen looping systems to generate acid and base streams. In several embodiments, the electrochemical hydrogen looping systems can generate acid and base streams directly from oceanwater. FIG. 3 illustrates a schematic of a hydrogen looping cell in accordance with an embodiment. The looping cell 100 includes a cathode 101, an anode 102, gas chambers 103 and 104, electrolyte chambers 105 and 106, and a physical separator 107. The electrochemical hydrogen loop cell 100 can have a symmetric structure. The gas chamber 103 is separated from the electrolyte chamber 105 by the anode 102. The gas chamber 104 is separated from the electrolyte chamber 106 by the cathode 101. A physical separator 107 between the chambers 105 and 106 can be implemented to keep the liquid electrolyte separate.

In the hydrogen looping cell, hydrogen and base are produced at the cathode 101 via the hydrogen evolution reaction (proton/water reduction) (2H⁺+2e⁻→H₂ and/or 2H₂O+2e⁻→H₂+2OH⁻), and hydrogen is consumed at the anode 102 via the hydrogen oxidation reaction (to form protons/water) (H₂→2H⁺+2e⁻ and/or H₂+2OH⁻→2H₂O+2e⁻). In various embodiments, equivalent hydrogen is produced and consumed at the cathode and anode, respectively, in the hydrogen looping cells. In net, hydrogen is looped from the cathode to the anode and no hydrogen is consumed or produced. The electrochemical hydrogen looping cell can be an H cell, a flow cell, a flow stack, or a cell stack. Water reduction at the cathode 101 generates a basic stream 108, and hydrogen oxidation at the anode 102 generates an acidic stream 109. The acidic stream 109 can have a pH greater than about 1 and less than about 7. The basic stream 108 can have a pH less than about 13 and greater than about 7.

The cathode 101 and anode 102 can be a gas diffusion electrode (GDE) to separate the gas and liquid phase and facilitate the hydrogen transmission. Any type of GDE that is compatible with (permeable to) hydrogen can be used as cathode and/or anode in the hydrogen looping cells. The cathodes and anodes can include catalysts that catalyze the reactions at the electrodes. Examples of catalysts include (but are not limited to) precious metals (such as platinum, palladium), earth-abundant metals (nickel, molybdenum, and manganese), sulfides, oxides, and phosphides. In some embodiments, coatings can be applied to the cathodes and/or anodes and act as a barrier to prevent gas and liquid from mixing. The coatings can be applied on the side of the GDE that is facing the liquid chamber. This coating layer can be a layer comprising a polymer material, a layer comprising a ceramic material, a layer with a positive electrical charge, a layer of a negative electrical charge, and/or a layer of a desired porosity and/or chemical structures. Examples of coating materials can include (but are not limited to) fluorinated ionomers, Nafion® ionomers, Nafion® D520 ionomers, SELEMION®, NEOSEPTA®, fumapem FAA, fumasep FAP, Versogen® PiperION-A5 ionomers, Fumasep membranes, Sustainion® membranes, Sustainion® ionomer, PiperION ionomer, and PiperION membranes. Some embodiments use non-fluorinated ionomers as coating materials. As can readily be appreciated, any of a variety of ionomers can be utilized as appropriate to the requirements of specific applications in accordance with various embodiments of the invention. In certain embodiments, non-ionomer polymers may be used as coating materials. The coating materials can be applied using a variety of methods such as (but not limited to) drop casting, spin coating, printing, spraying. Coating on the electrodes can improve the current density of the hydrogen looping systems. Some embodiments implement polarity switching to prevent buildup of precipitates and to remove precipitates from the electrodes in order to improve current density.

The electrolyte chambers 105 and 106 can include various types of electrolytes 111. The electrolytes can be dissolved in water or organic solvent. Several embodiments use high concentrations of sodium chloride in the electrolyte (greater than or equal to about 0.5 M; or ionic concentrations similar to oceanwater) such that the ionic current in the electrolyte is carried by sodium and chloride ions, not protons and hydroxide ions.

The electrochemical hydrogen looping system 101 uses a physical separator 107 to keep the acid and base streams from mixing. The system can avoid using expensive and failure-prone membrane-based separators. Examples of the physical separator can include (but are not limited to) filter paper, qualitative grade filter paper, quantitative grade filter paper, glass fiber filter, quartz fiber filter, chromatography filter paper, coffee filter paper, tea filter paper, ceramic membranes, ceramic filters. Some embodiments use VWR qualitative grade filter papers or sodium superionic conductor (NASICON) ceramic membranes as physical separators. The ceramic membranes can allow for sodium ion transport between the catholyte and anolyte without allowing proton crossover, enabling higher currents and thinner cells to produce more concentrated acid and base streams. In certain embodiments, if laminar flow can be achieved in the hydrogen looping systems, a physical separator may not be needed. Catholyte of laminar flow and anolyte of laminar flow can have minimized mixing when the two electrolytes are in contact. The minimized mixing can eliminate the use of a physical separator 107 to separate the catholyte and the anolyte. In order to achieve laminar flow, several embodiments can modify coating layers on the cathodes and the anodes, modify the design of the liquid inlets and/or outlets, control the flow rate and/or flow directions, and/or modify the fluid pump to achieve a less turbulent fluid flow. In many embodiments, catholyte and anolyte of laminar flow can also utilize a physical separator in order to minimize mixing of the electrolytes.

The hydrogen gas can be externally looped 110 such that no net hydrogen is consumed or produced via redox processes. The external hydrogen loop 110 can act as a hydrogen pump. The hydrogen loop 110 can be made of various tubes, pipes, channels, and any type of a gas flow channel that is compatible with (but not corroded by) hydrogen gas. The hydrogen flow channels can be sealed with tapes and/or gaskets such as (but not limited to) O rings, washers to prevent hydrogen leakage. Variations in channel width, flowrate, and applied currents/voltages can affect the outlet composition and overall energy efficiency. Cell design can be optimized to accommodate the tradeoffs in current, cell geometry, and liquid flowrates on efficiency.

In many embodiments, the electrochemical hydrogen looping systems can achieve current densities greater than or equal to about 100 mA/cm²; or greater than or equal to about 200 mA/cm²; or greater than or equal to about 300 mA/cm²; or greater than or equal to about 400 mA/cm²; or greater than or equal to about 500 mA/cm²; or less than or equal to about 500 mA/cm². The electrochemical hydrogen looping systems in accordance with several embodiments can be operated at voltage lower than or equal to about 6 V; or lower than or equal to about 5 V; or lower than or equal to about 1.5 V; or lower than or equal to about 1.0 V. The electrochemical hydrogen looping systems can maintain the performance and operate for extended periods of time such as (but not limited to) at least 1 hour; or at least 10 hours; or at least 20 hours; or at least 30 hours; or at least 40 hours; or at least 50 hours; or at least 100 hours; or at least 110 hours; or at least 120 hours; or at least 130 hours; or at least 140 hours; or at least 150 hours; or at least 500 hours; or at least 1000 hours; or greater than about 1000 hours.

The hydrogen looping cells can be in various sizes with a planar active surface area ranging from about 1 cm² to about 1 m²; or from about 1 cm² to about 10 cm²; or from about 10 cm² to about 50 cm²; or from about 50 cm² to about 1 m²; or greater than about 1 m². The electrochemical hydrogen looping systems in accordance with many embodiments are modular and scalable, and enable low cost systems for carbon capture from oceanwater.

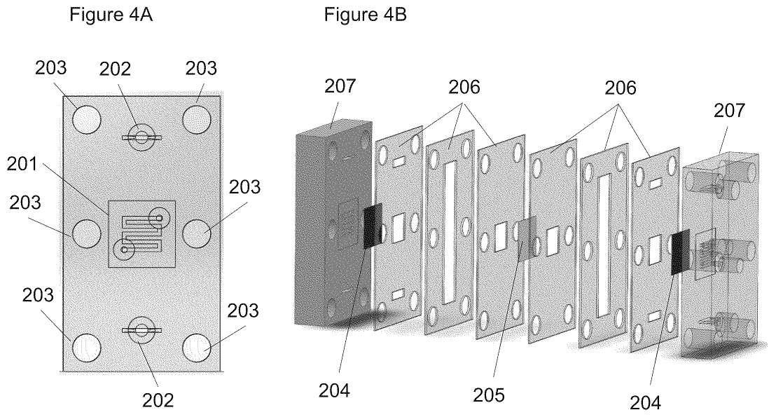

FIG. 4A illustrates a schematic of a 3D-printed end plate of a hydrogen looping cell in accordance with an embodiment. The end plate of the cell has serpentine gas diffusion patterns 201 in the middle and ports 202 for electrolyte flow at the top and bottom. Holes 203 for screws can be used to secure the cell. FIG. 4B illustrates a disassembled hydrogen looping cell in accordance with an embodiment. The cell can include the end plates 207, gaskets 206, GDEs 204, and separators 205. A channel for the electrolyte can be created by the gaskets. The gaskets can have various thickness from about 0.01 inch to about 0.1 inch; or from about 0.01 inch to about 0.05 inch. The gaskets can be made of a variety of materials including (but not limited to) fluoropolymers such as polytetrafluoroethylene, Teflon®, Viton®; and silicone. The electrodes can be connected with current collectors comprising metals or metal alloys.

Systems and methods for electrochemical hydrogen looping systems in accordance with various embodiments of the invention are discussed further below.

### Electrochemical Hydrogen Looping System

Many embodiments implement electrochemical hydrogen looping systems (also referred as hydrogen looping cells, or cells) for generating acid and base streams from oceanwater. The hydrogen looping systems can be used for direct ocean capture of carbon dioxide. By acidifying oceanwater, the equilibrium of the bicarbonate buffer shifts toward dissolved carbon dioxide, which can be removed and sequestered. In the hydrogen looping systems, the theoretical minimum voltage can be dictated by the Nernstian shift in the equilibrium potentials as a function of pH, and is less than about 1 V. Similarly, kinetic overpotentials are generally less than about 0.5 V, due to hydrogen oxidation and water reduction being facile reactions with gas diffusion electrodes even at higher current densities. The hydrogen looping systems do not use ion-exchange membranes, which reduces costs. The systems can achieve current densities less than or equal to about 300 mA/cm² with off-the-shelf GDEs. Some embodiments modify the GDEs with polymer coatings to achieve current densities less than or equal to about 500 mA/cm². Several embodiments implement polarity switching to operate the cell for one hour without electrode fouling causing when operated using simulated oceanwater.

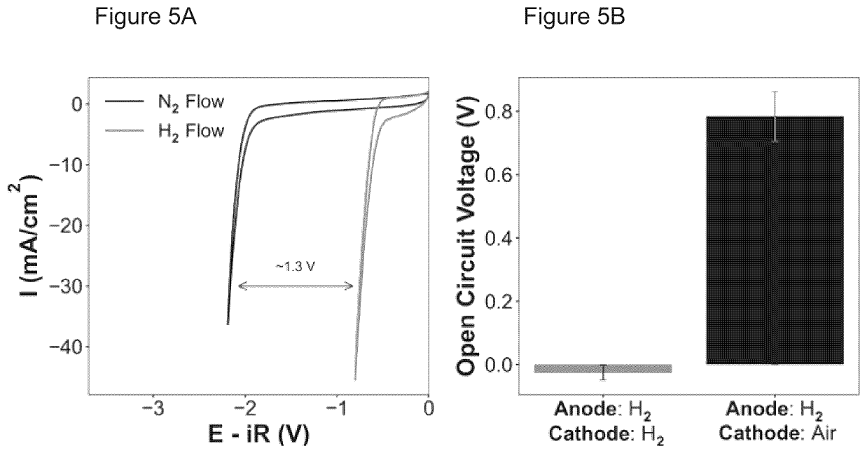

The HER in electrolysis and the HOR in fuel cells can achieve current densities of greater than about 1000 mA/cm². In several embodiments, anodic water oxidation can be replaced by hydrogen oxidation by looping hydrogen generated at the cathode to the anode. The overall system potential can be reduced by up to about 1.23 V by avoiding water oxidation reactions at the anode. Some embodiments replace nitrogen gas at the anode with hydrogen gas to show that using hydrogen gas at the anode can lower the overall system potential. FIG. 5A illustrates current density and potential under different gas flows at the anode in accordance with an embodiment. FIG. 5A shows potential differences under hydrogen flow in comparison to nitrogen flow at the anode in order to reach similar current density. When hydrogen is used at the anode, there is a noticeable change in the electrochemistry of the system, shown by the about 1.3 V decrease in the potential to drive nonnegligible current.

In certain embodiments, when hydrogen is present at both the anode and the cathode, an open circuit voltage of about zero can be achieved, representing a hydrogen pump. FIG. 5B illustrates open circuit potential of an electrochemical cell when different gases are present at the cathode and the anode in accordance with an embodiment. When hydrogen is present at the anode and air is present at the cathode, an open-circuit potential of about 800 mV is shown, consistent with open-circuit potentials of fuel cells. In comparison, having hydrogen at both the anode and cathode results in an open-circuit potential of about 0 mV. The values in FIG. 5B are the average of three measurements with the error bars being the standard deviation.

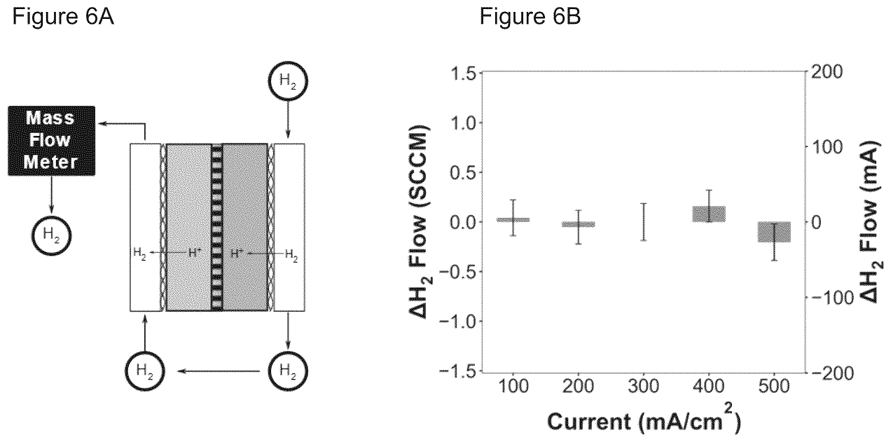

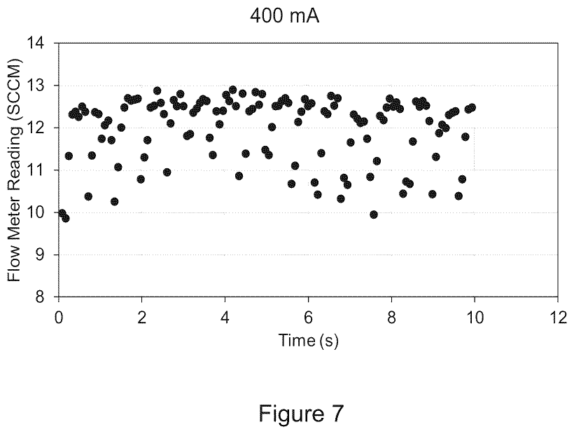

When a current is passed through the device, analysis of data from a mass flow meter indicates that hydrogen is consumed and produced in equal quantities at the anode and cathode, respectively. FIG. 6A illustrates a mass flow meter connected at the outlet of a hydrogen looping system in accordance with an embodiment. FIG. 6B illustrates the change in hydrogen flow when a current is applied versus no current applied in accordance with an embodiment of the invention. FIG. 6B shows that equivalent amounts of hydrogen are consumed at the anode and produced at the cathode. Changes in hydrogen flow of less than 0.5 SCCM are observed for galvanostatic measurements over a range of current densities from about 100 mA/cm² to about 500 mA/cm², representing an equivalent change in flow of less than 10% of the passed current. The values in FIG. 6B are the average of two experiments at each current density with the error representing the average of the standard deviations for each experiment. Deviations from zero in FIG. 6B can be due to a combination of hydrogen bubbles leaking through the gas diffusion electrodes into the liquid electrolyte, observed at high currents at the cathode, as well as the large errors in the flow meter reading due to the gas-liquid interface. FIG. 7 illustrates variation in flow meter readings over time during quantification of hydrogen gas looping in accordance with an embodiment. This variation is due to bubbles and the contact between the gas and liquid streams through the gas diffusion electrode. The variation disappears when the liquid electrolyte is not pumped. In various embodiments, hydrogen is present at both electrodes and the looping system is functioning.

Several embodiments characterize system performance by evaluating the relationship between current and voltage as well as the pH of the effluent electrolyte for each compartment. The thermodynamic equilibrium potential at each electrode, where hydrogen is either produced or consumed (Equation 3a and 3b for acidic and basic environments, respectively), is given by a Nernstian relationship as a function of pH (Equation 4).

2H⁺+2e⁻ [symbol] H₂ (3a)

2H₂O+2e⁻ [symbol] H₂+2OH⁻ (3b)

E^{eq}=(−60 mV)pH vs. SHE (4)

In addition, there are kinetic overpotentials (ii) and a solution resistance potential drop in the cell, which are dependent on the current density as well as the cell geometry. The cell voltage should be a function of the pH, current density, overpotential, cell geometry, and liquid flowrate (Equation 5).

$$\begin{matrix}{V}_{cell} = 0.06 \vert Δ pH \vert + η + i \frac{2 ρ d}{A} & ( 5 ) \\ pH = - {log}_{10} [ \frac{i}{F \dot{V}} ] & ( 6 )\end{matrix}$$

Here, d is the width of each cell compartment, A, is the electrode area, ρ is the solution resistivity, i is the applied current, ΔpH is the pH difference between the cathode and anode, F is the Faraday constant, \dot{V} is the liquid flowrate through each compartment (for example, less than or equal to about 8 mL/min; or greater than or equal to about 8 mL/min), and pH is the pH at the electrodes, which in turn is a function of the current density and flowrate (Equation 6). At low current densities, the cell voltage will be dominated by the equilibrium potential and kinetic overpotentials, while at high current densities, the cell voltage will be dominated by resistive potential drops.

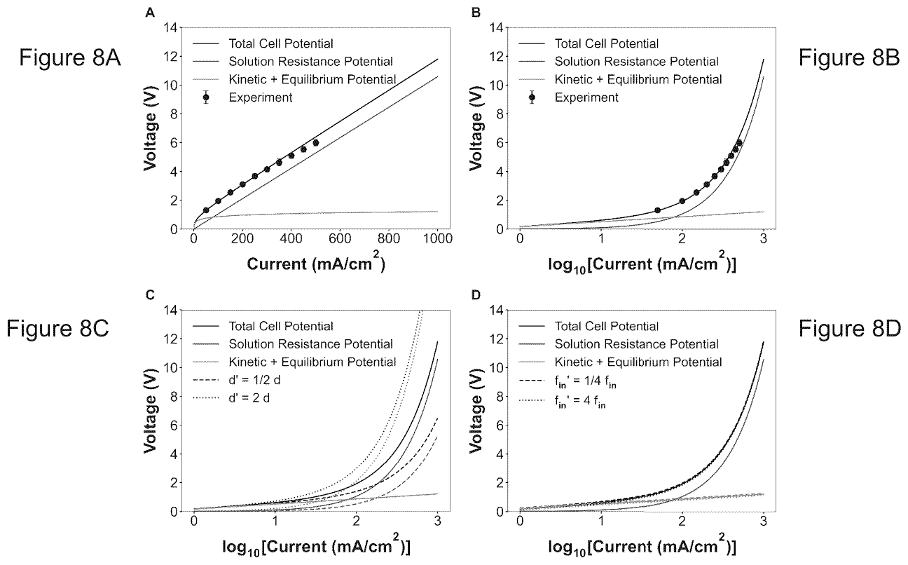

FIGS. 8A through 8D illustrate plots of Equation 5 in accordance with an embodiment of the invention. FIGS. 8A through 8D show the total cell potential, the solution resistance potential and the sum of the kinetic overpotential with the equilibrium potential. Geometry parameters and Butler-Volmer parameters can be the same for the COMSOL Multiphysics model (more discussion later). The conductivity of oceanwater, σ=3.31 S/m, can be used. First, the equilibrium and kinetic overpotentials dominate at low currents, but the resistance dominates at high currents, as expected and shown in FIG. 8A. The current is plotted on log-scale to further exhibit this point in FIG. 8B. There is a strong influence of the cell width, d, on the voltage profiles, which scale like a resistor linearly with d in FIG. 8C. There is a minor influence of flowrate in FIG. 8D, since the only influence of flowrate on the system is through the pH, which will be a logarithmic relationship (Equation 6).

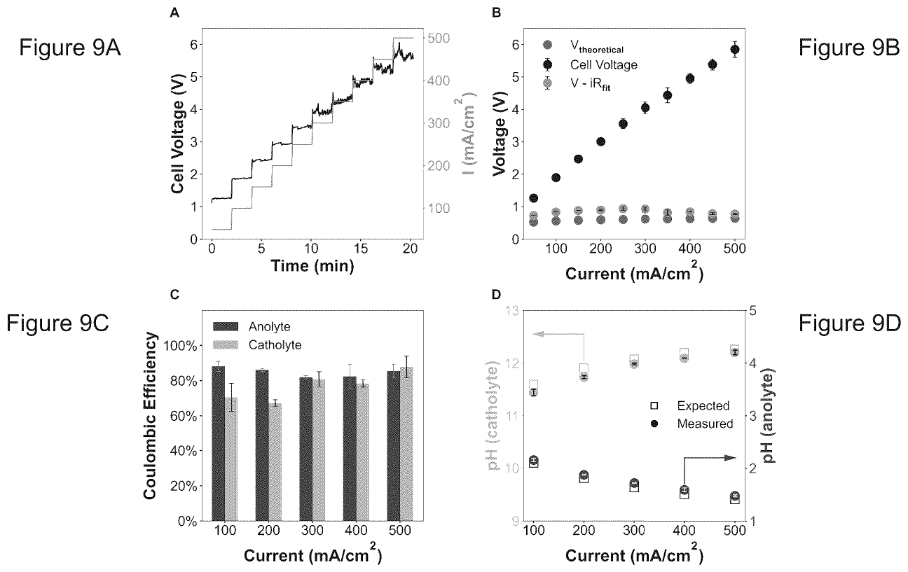

Experiments with current density ranging from 0 mA/cm² to 500 mA/cm² are carried out to measure the steady-state voltage galvanostatically. FIGS. 9A through 9D illustrate electrochemical characterization of the hydrogen looping system in accordance with an embodiment. Values in FIGS. 9B through 9D are average values of three measurements with the error bars being the standard deviation. As the current density increases, the noise in the voltage also increases, which may be due to increasing production of small bubbles inside the electrolyte. FIG. 9A shows that the noise in the voltage remains less than about 0.5 V from 100 mA/cm² to 500 mA/cm², and the average voltage remains steady on the order of a few minutes. To reach 500 mA/cm², the electrodes can be coated with Nafion® ionomers to physically hinder bubble formation in the electrolyte at high current densities. The Nafion® ionomers can be drop cast onto the platinum catalyst on the gas diffusion electrode (GDE) and oriented to face the liquid electrolyte. The Nafion® ionomer can form a barrier that helps keep the liquid and gas separate. Without the Nafion® layer, bubbles are visually apparent in the electrolyte and the resulting solution resistance increases due to bubble formation and subsequent pressure gradients can cause the cell to fail at current densities above about 300 mA/cm². At about 200 mA/cm², however, the cell voltage is stable over the course of one hour without any Nafion® ionomer.

Average voltage scales almost linearly with current density, like a resistor. Averaging over time for each applied current in FIG. 9A produces FIG. 9B, where the voltage-current relationship of the full cell (Cell Voltage) acts as a resistor due to solution resistance. When the solution resistance is subtracted (V−iR_{fit}), the voltage agrees well with theoretical thermodynamic potentials based on the Nernstian shift due to pH gradients (V_{theoretical}). These data suggest, as the calculations indicate (Equations 5 and 6), that the cell behaves like a resistor at operating current densities.

In addition to the relationship between current density and voltage, several embodiments provide the Coulombic efficiency and the outlet pH of the system. The Coulombic efficiencies for each compartment (defined as the ratio of proton or hydroxide flux out of each compartment to the maximum possible proton or hydroxide flux at the given current) are approximately 80% at current densities up to 500 mA/cm² (FIG. 9C). This means that 80% of the current net produces protons and hydroxides in the acidic and basic streams, respectively. Less than 100% Coulombic efficiency can be due to crossover induced by turbulent mixing from small bubble formation in the electrolyte and the roughness of the cell surfaces. In a system with ideal laminar flow, no mixing of the acid and base streams should be expected and thus no crossover of protons and hydroxides. The Coulombic efficiency results can similarly be shown as pH values for the acidic and basic outlets (FIG. 9D). At about 500 mA/cm², the pH reaches values of less than about 2 (for example about 1.5) in anolyte, and greater than about 12 (for example about 12.5) in catholyte with about 8 mL/min flow at the acidic and basic streams, respectively. Even at lower current densities, the outlet can achieve relatively extreme pH values due to the logarithmic relationship between current and pH (Equation 6).

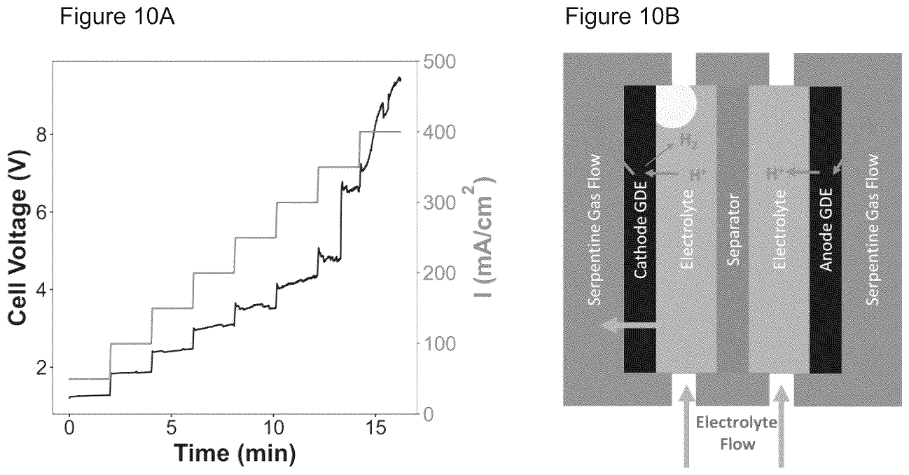

FIGS. 10A and 10B illustrate galvanostatic staircase data for a cell without Nafion® ionomer coating on the electrodes in accordance with an embodiment. In FIG. 10A, the cell voltage is stable up to about 250 mA/cm² (at about 300 mA/cm², the voltage is not stable for long time periods). FIG. 10B shows a schematic of bubble formation without ionomer coating. Larger current densities result in increased bubble formation inside the electrolyte. These bubbles may detrimentally affect pressure balance in the gas diffusion electrodes, causing wetting by pushing liquid electrolyte into the GDE and increasing the cell resistance.

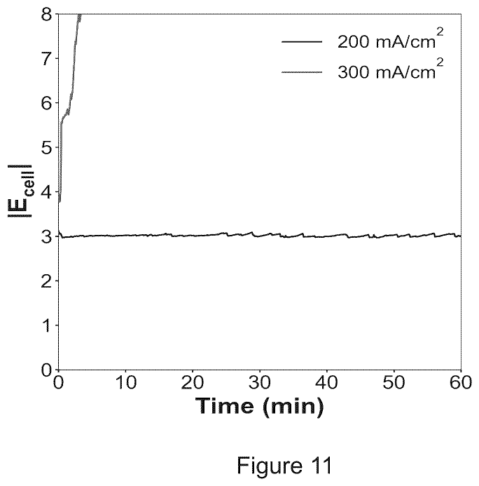

FIG. 11 illustrates chronopotentiometry data at about 200 mA/cm² and about 300 mA/cm² without Nafion® ionomer coating on the electrodes in accordance with an embodiment. The voltage remains steady at about 200 mA/cm², but not at 300 mA/cm², suggesting that an ionomer coating is important for maintaining stable voltage at current density higher than about 200 mA/cm².

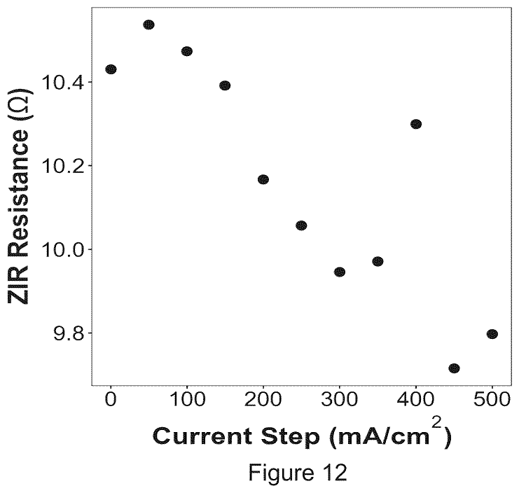

FIG. 12 illustrates resistance measured via a single 100 kHz impedance measurement before and after each galvanostatic step in FIG. 9A in accordance with an embodiment. As the current increases, pH changes become larger, which results in a decreased resistance.

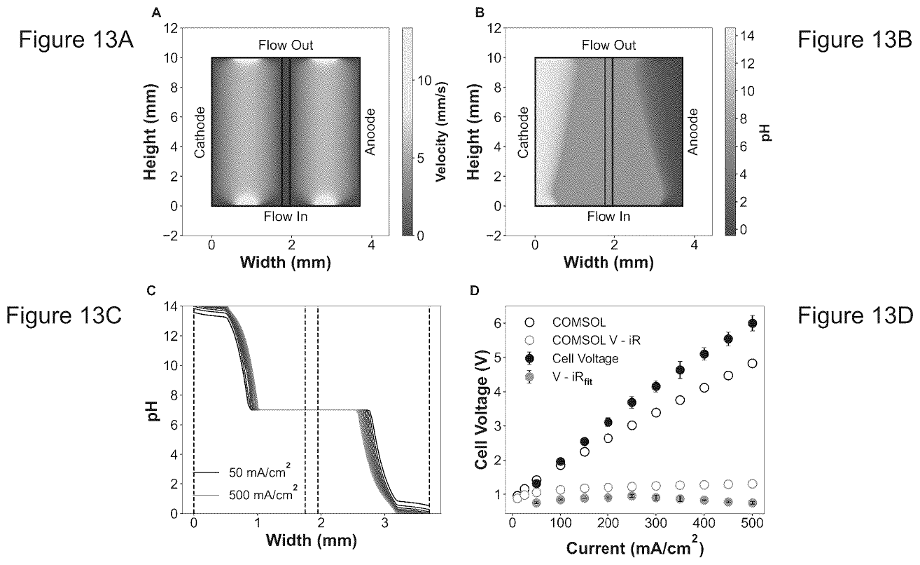

Several embodiments implement multiphysics modeling to simulate the fluid dynamics, concentration gradients, and electrochemistry of the system. As can be readily appreciated, a variety of multiphysics software such as (but not limited to) with COMSOL Multiphysics, MATLAB, Mathematica, can be used for modeling. First, while the flowrate does influence the pH of the system, in practice this influence can be small due the logarithmic relationship between pH and flowrate (Equation 6). Additionally, in the overall system, the proton flux is an important parameter because one proton is needed to convert each bicarbonate ion into a gaseous carbon dioxide molecule (Equation 1). Thus, flowrate can be controlled to keep the system under laminar flow and avoid proton crossover. Minimizing flowrate can reduce pumping energy needed to flow the electrolyte through the electrochemical cell. FIGS. 13A through 13D illustrate COMSOL Multiphysics modelling of the hydrogen looping cell in accordance with an embodiment. The hydrodynamics of the electrolyte in the cell match laminar flow intuition when modeled in COMSOL Multiphysics as shown in FIG. 13A. When a current density of about 500 mA/cm² is applied to the cell, the pH gradient near the inlets does not extend far into the cell, but the pH gradient near the outlets extends about 1 mm into the cell, resulting in pH gradients that are largest near the electrode at 500 mA/cm² applied current density (FIG. 13B). Ideally, the cell can be made as thin as possible to minimize solution resistance (Equation 5). However, the observed pH gradient limits the width of the cell since convection and sodium chloride migration can prevent protons and hydroxides from crossing the separator and recombining. Thus, the cell compartment width can be greater than or equal to about 1 mm to avoid proton crossover.

As seen in FIGS. 13B and C, cells thinner than about 1 mm can result in proton crossover and lower Coulombic efficiencies. As currents get larger and liquid flowrates decrease, the pH gradients may shift closer to the middle of the cell where crossover would occur, but this is negligible compared to the extreme pH values near the electrodes. pH gradient cross sections of the system as shown in FIG. 13C, shows that the extreme pH values are localized within the about 0.5 mm nearest the electrodes, suggesting that a small amount of crossover may not affect the overall pH of the electrolyte due to the logarithmic nature of pH with respect to proton concentration. Additionally, the pH gradient cross sections reveal that the pH gradients near the electrodes are not strongly influenced by current density (FIG. 13C) or flowrate.

When the cell voltages predicted by COMSOL Multiphysics are compared to the experimentally measured cell voltages as shown in FIG. 13D, both the total cell voltage as well as the resistance compensated voltages agree well. The discrepancies in the total cell voltage are likely due to extra resistance from, for example, electrode contacts and the separator model used by COMSOL Multiphysics. The discrepancies in the resistance compensated voltage can be due to the kinetic parameters chosen for the model compared to actual values. Overall, the COMSOL Multiphysics model reveals how cell geometry plays an important role in this system.

In terms of device scalability, several embodiments use an order-of-magnitude argument to understand the concentration gradients and timescales involved. The concentration gradients will have a characteristic length scale that is proportional to \sqrt{A×d/fᵢₙ}, where A is the area of the electrode surface parallel to the flow, d is the compartment thickness, and fᵢₙ is the volumetric flowrate. If electrode area and flowrate are scaled together, the concentration gradients should not increase, preventing proton crossover at the separator even in the case of large electrodes. While this scaling makes it appear that the flowrate can be increased to reduce the thickness, and therefore reduce the cell resistance. In practice the flowrate may not have a large impact on the concentration gradients in the ˜0.5 mm nearest the electrode.

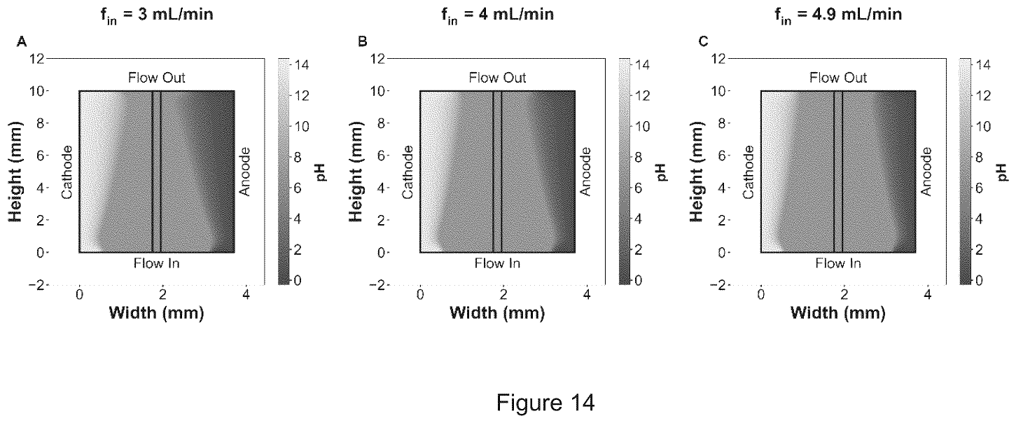

FIG. 14 illustrates COMSOL Multiphysics pH maps at various flowrates in accordance with an embodiment. The pH color maps at various flowrates around 4 mL/min show the influence of flowrate is minimal. The current density in these simulations is about 400 mA/cm².

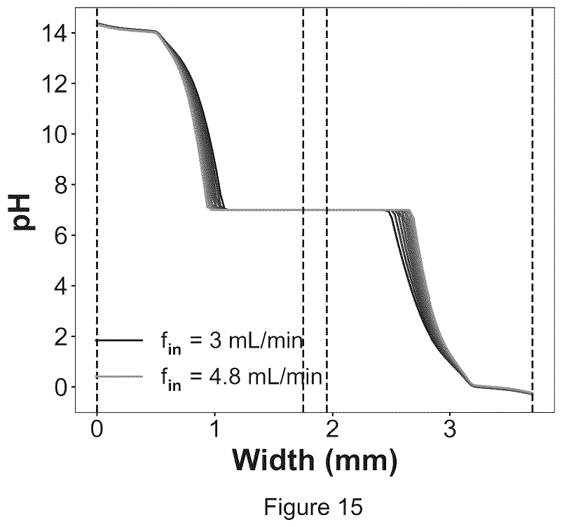

FIG. 15 illustrates pH lines at the outlet of the cell at various flowrates in accordance with an embodiment. The dashed line on the left is the cathode and on the right is the anode. The dashed lines in the middle represent the separator. The influence of flowrate can be minimal. The influence of flowrate also decreases as the flowrate increases. The current in these simulations is about 400 mA/cm².

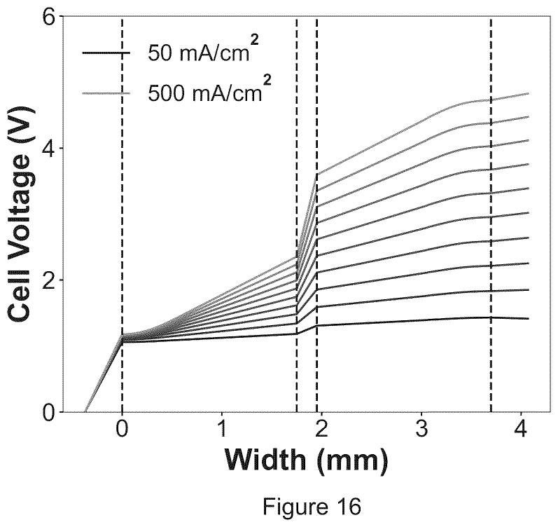

FIG. 16 illustrates breakdown of voltage drops across cell in accordance with an embodiment. These lines represent the voltage drops across the cell at the midpoint of the cell (0.5 cm into the electrode). The left dashed line represents the cathode and the right dashed line represents the anode. The voltage drops “outside” the cell are not to scale and represent the overpotential for the reactions at the electrodes. Hydrogen evolution in alkaline media (cathode, left) has a larger overpotential than hydrogen oxidation in acidic media (anode, right). Note that the voltage drop across the separator (middle dashed lines) is significant, but still less than about 1 V.

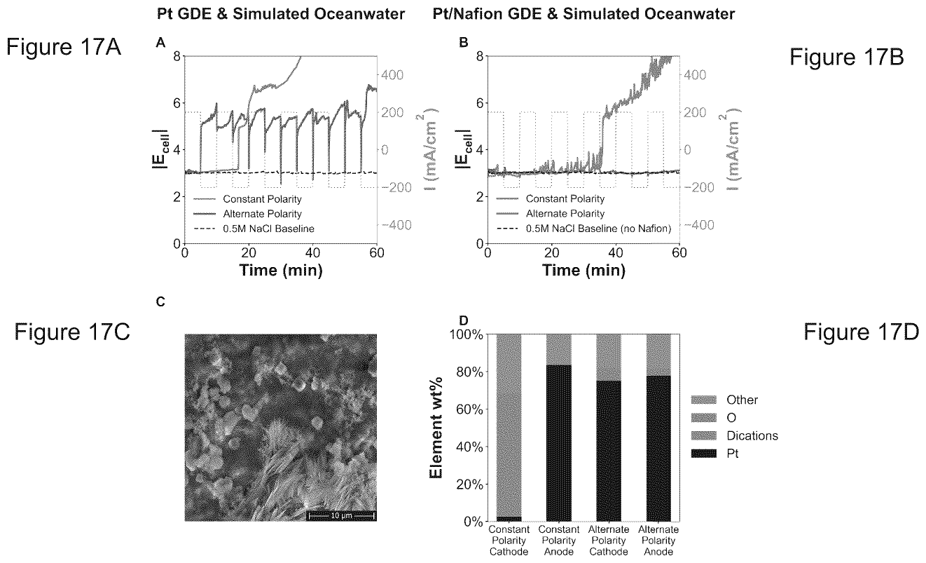

Oceanwater can contain dications such as magnesium and calcium besides sodium chloride. The dications may precipitate on surfaces in the form of hydroxides or carbonates. This can be a challenge in electrodialysis and in systems that experience membrane fouling due to precipitation of dications. Softening of the oceanwater with overall dication concentration of less than about 1 ppm is often required for long-term bipolar-membrane-based electrodialysis operation. Several embodiments overcome membrane fouling by implementing polarity switching, where a reversal of the electric field results in acidified compartments becoming basic and vice versa. Bipolar membrane-based electrodialysis is not suited for reversal of polarities as water recombination at the bipolar membrane interface could cause bipolar membrane performance degradation for long-term operation. Unique to the hydrogen looping system, because the electrodes and cell geometry are symmetric, polarity switching can enable the use of oceanwater without electrode fouling due to precipitates. When the cell is operated at about 500 mA/cm², the rate of formation of precipitate can be too rapid due to the extreme pH values at the electrode surface. Polarity switching may not be able to effectively mitigate net precipitation, as switching the polarity may not re-dissolve precipitates before cell failure due to resistance increases. When the current density is reduced to about 200 mA/cm², the rate of precipitation becomes slow enough that polarity switching can remove precipitates from the electrode in accordance with various embodiments. FIGS. 17A through 17D illustrate the influence of polarity switching using simulated oceanwater as a liquid electrolyte in accordance with an embodiment. In both cases, the cell voltage measured over one hour at a current density of about 200 mA/cm² is compared for the condition of simulated oceanwater versus the baseline case of a cell with aqueous 0.5 M NaCl as the liquid electrolyte, where the voltage remained steady. FIGS. 17A and 17B show hydrogen looping cell tests with square-wave polarity switching between ±200 mA/cm² every 5 min for two cases: Pt gas diffusion electrodes without ionomer coating (FIG. 17A) and Pt gas diffusion electrodes with Nafion® ionomer (FIG. 17B). FIG. 17A shows that the cell fails after about 20 min at constant polarization using simulated oceanwater (Constant Polarity). When the polarity is alternated every 5 min instead (Alternate Polarity), the voltage is around 5-6 V over the entire hourlong test yet is much larger than the baseline case using aqueous 0.5 M NaCl (˜3 V and stable). Note that the voltage increases during each 5 min galvanostatic period but then “resets” with a switch in polarity. Polarity switching using electrodes without ionomer every five minutes for an hour removes the precipitate at roughly the rate of deposition, achieving a steady state operation in the presence of dications. However, the cell resistance due to a steady-state precipitate coverage is higher than with the 0.5 M NaCl electrolyte (ca. 5.5 V compared to 3 V), suggesting that this strategy is infeasible for practical applications.

FIG. 17B shows the cell with Nafion® ionomer coated electrodes begins to fail at around 40 min (Constant Polarity). The polarity switching case, however, is steady for about 60 min (Alternate Polarity). Over the first 10 min, the voltage increases in the case with simulated oceanwater. Polarity switching every five minutes can prevent noticeable precipitate buildup, and the voltage remains steady at the same value as with the 0.5 M NaCl electrolyte. In both cases with and without Nafion® ionomer, the cell voltage increases steadily over the period of minutes due to precipitation.

There is visual evidence of salt precipitation at the cathode in the case of constant polarity testing shown for the electrode from the constant polarity test in FIG. 17B. FIG. 17C shows SEM images of electrodes with ionomer coatings after polarity switching tests. The SEM images reveal crystalline precipitate formation at the cathode with negligible crystal formation at the anode, which are basic and acidic during operation, respectively. In the case of alternating polarity with ionomer, there is negligible precipitate buildup on either electrode. Note that for the alternating polarity case, “cathode” and “anode” refer to the electrode operation during the last five-minute period.

FIG. 17D shows the EDS mapping of the cathode and anode. The EDS mapping confirms the presence of salt precipitation on the cathode for the tests from FIG. 17B. From EDS, the cathode under constant polarity is covered in dications (Mg²⁺ and Ca²⁺) and oxygen, whereas the anode and both electrodes in the case of alternating polarity are primarily platinum. This indicates that dicationic hydroxide solids (i.e., Mg(OH)₂ and Ca(OH)₂) are likely blocking Pt active sites. These results suggest that the Nafion® ionomer not only prevents bubble formation at high current densities but also mitigates irreversible electrode fouling with simulated oceanwater at lower current densities. Various types of ionomers and/or the physical coverage of the polymer on the electrodes may affect the electrode performance in the hydrogen looping cells.

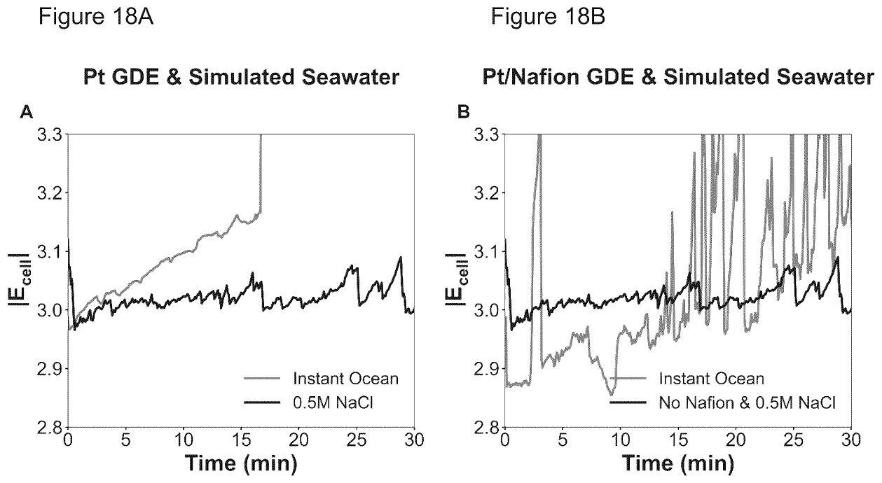

FIGS. 18A and 18B illustrate voltage increase in hydrogen looping cell test with polarity switching between ±200 mA/cm² in accordance with an embodiment. Voltage increase can be seen on timescales as short as minutes, with simulated oceanwater without (FIG. 18A) and with (FIG. 18B) Nafion® ionomer coating.

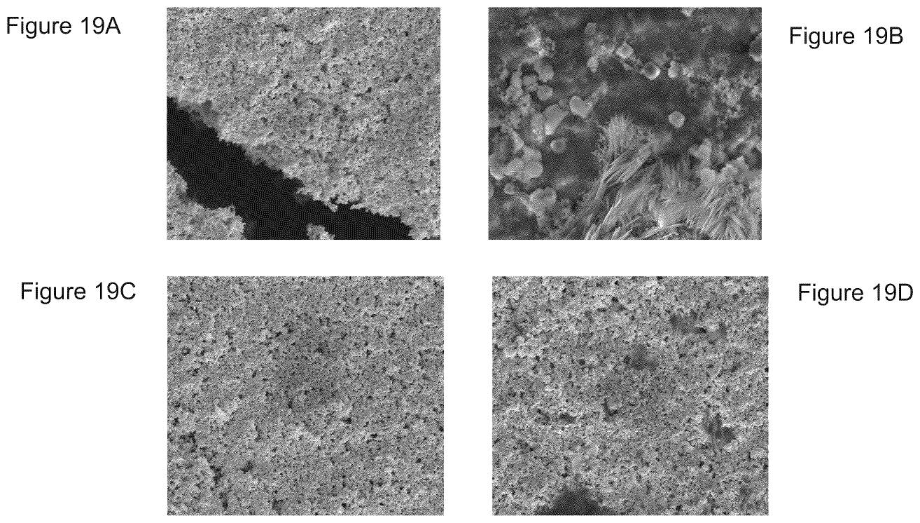

FIGS. 19A through 19D illustrate post-electrolysis SEM images of electrodes in FIG. 16B in accordance with an embodiment. In the case of constant polarity, the anode shows no signs of precipitates (FIG. 19A), but the cathode is covered in crystals (FIG. 19B). In the case of alternating polarity, the electrode that is the anode during the final time step shows no precipitates (FIG. 19C) but the electrode that is the cathode during the final time step shows some small crystals (FIG. 19D).

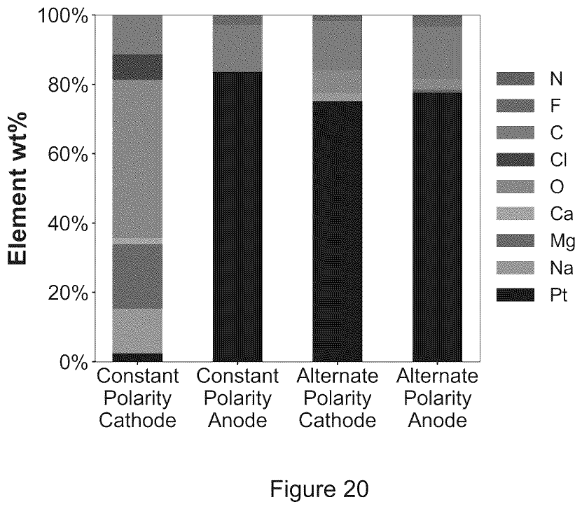

FIG. 20 illustrates EDS results from electrodes from FIG. 16B in accordance with an embodiment. Note that calcium, sodium, and magnesium hydroxide precipitate out, with minimal chlorides.

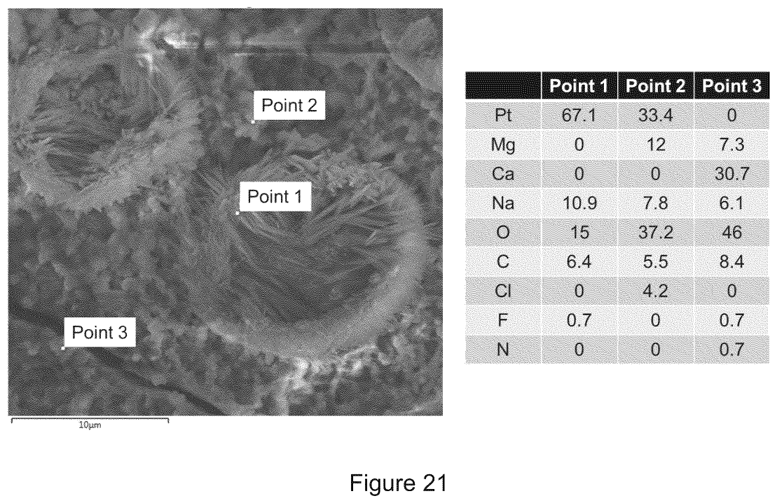

FIG. 21 illustrates EDS point mapping of crystals in accordance with an embodiment demonstrating that calcium, magnesium, and sodium hydroxide are being formed. Point 1 is primarily sodium hydroxide, point 2 is primarily magnesium and sodium hydroxide, and point 3 is primarily calcium hydroxide with some magnesium and calcium hydroxide. Each point is on crystals that have different visual shapes.

### EXEMPLARY EMBODIMENTS

Although specific embodiments of systems and apparatuses are discussed in the following sections, it will be understood that these embodiments are provided as exemplary and are not intended to be limiting.

### Example 1: Electrochemical Cell Preparation

The electrodes can be Sigracet 28BC gas diffusion electrodes sputtered with approximately 100 nm of platinum metal. 100 μL of Nafion® D-520 can be drop cast onto a 1.5 cm by 1.5 cm square electrode surface and dried at about 80° C. The electrodes are then attached to the aluminum current collector in the cell using Kapton tape. The cell includes two 3D-printed resin endplates with serpentine gas channel and ports for electrolyte flow. Teflon gaskets are used to form a channel for electrolyte flow by the electrode surface, with a channel thickness of approximately 1.78 mm. The exposed electrode surface area is about 1 cm by 1 cm. Hydrogen gas flows through the cell at 20 SCCM, passing through the anode gas diffusion electrode and then through the cathode gas diffusion electrode. A physical separator (VWR filter paper 410) divides the catholyte and anolyte flows. The electrolyte can be 0.5 M NaCl in deionized water, with the exception of the simulated oceanwater experiments, which uses Instant Ocean salt.

Solvents and reagents are obtained from commercial sources and used as received, unless stated otherwise. Materials include Sigracet 28BC carbon paper, sodium chloride, Instant Ocean sea salt, Nafion® D-520, VWR filter paper (qualitative, 410), photopolymer resin (Formlabs photopolymer resin clear FLGPCL040).

Electrodes are prepared by sputtering about 100 nm of platinum metal onto the microporous layer (MPL) of a Sigracet 28BC gas diffusion electrode. A sputtering machine can be used with Ar gas in a pressurized environment and room temperature deposition conditions. Each electrode can be a 1.5 cm by 1.5 cm square placed over the serpentine gas channel. Nafion® D-520 can be drop cast onto the platinum surface and dried at 80° C. and then allowed to cool to room temperature to create an ionomer coating.

The cell includes two 3D printed resin endplates each with serpentine gas channel and ports for electrolyte flow. Teflon gaskets can be used to direct and control the electrolyte flow in the cathode and anode chambers, with total channel thickness at the electrode of about 0.07 in (1.78 mm, measured experimentally to be 1.75 mm with calipers). Aluminum current collectors are used around each serpentine gas flow channel and Kapton tape are used to keep the electrode pressed against the current collector, which in turn is pressed onto the endplate. The Teflon gaskets expose about a 1 cm by 1 cm electrode area. A physical separator (VWR filter paper 410) is used to prevent convective crossover of the electrolyte between the cathode and anode chambers. Hydrogen gas flowed at 20 SCCM via a flow controller into the anode and then looped around to the cathode. Electrolyte (aqueous 0.5 M NaCl unless otherwise noted), can be pumped from the bottom to the top of the cell with peristaltic pumps. The flowrate is calibrated to about 8 mL/min after cell assembly and before each experiment.

### Example 2: Electrochemical Characterization

Electrochemical experiments can be performed with a Biologic SP-200 potentiostat. Solution resistance is measured using the ZIR function, which takes a single high-frequency impedance measurement at 100 kHz. Outflow of the electrolyte is analyzed via titration when necessary to calculate the pH and quantify the Coulombic efficiency of the cell.

### Example 3: Product Quantification and Analysis

Products of the experiments include an acid stream or a base stream. Titrations are used to calculate the pH of the effluent from the anolyte and catholyte. In short, post-electrolysis electrolyte is pumped using a syringe pump into 15 mL of 1 mM phosphate buffer while measuring the pH using a Hanna Instruments pH meter. The volume of electrolyte added until the inflection point of the titration curve is then used to calculate the activity of protons (pH) in the post-electrolysis electrolyte.

SEM and energy-dispersive X-ray spectroscopy (EDS) of the electrodes post-electrolysis with simulated oceanwater is taken using an FEI Nova NanoSEM 450. The cell is flushed with deionized water for about 30 seconds after electrolysis to remove loose salt and the electrodes are then dried overnight at ambient conditions before analysis.

For hydrogen quantification, a mass flow meter can be used. In approximately one-minute intervals, the cell is operated at open circuit potential, followed by an applied current, followed by open circuit potential, etc. The values of the mass flow meter are recorded over the last 10 seconds of each step. The difference between the applied current flowrate and the average of the open circuit flowrates is then calculated and plotted. The error bars represent the average of the standard deviations over the 10 second period recording the noisy gas flowrate data.

### Example 4: COMSOL Multiphysics Modelling

COMSOL Multiphysics 5.6 is used to model the system with the default tolerances and solver configurations. At the anode, hydrogen oxidation in acid is used with Butler-Volmer kinetics, and at the cathode, hydrogen evolution in base is used with Butler-Volmer kinetics. The exchange current densities are 70 mA/cm² and 0.4 mA/cm², respectively, and the transfer coefficients are 0.5. Liquid flowrates of 4 mL/min are used due to convergence issues at higher flowrates.

The governing equations (material balances and fluid dynamics) are used within the Multiphysics Module and are solved with the general solver in COMSOL Multiphysics 5.6 with default tolerances. The modeling domain is discretized with a nonuniform physics-controlled mesh generated by COMSOL Multiphysics. The width of each chamber is 1.75 mm (measured from the experiments) with the inlet and outlet flows combing through the middle 0.75 mm. Inlet velocity boundary conditions are set to fully developed flow with the flowrate set to 4 mL/min to help the system converge (compared to 8 mL/min, which is the value used in experiments). While the flowrate does impact the results, the differences are generally qualitative on the order of the operational flowrates. Outlet boundary conditions are set to developed flow with an average pressure of 0 Pa. The electrode reactions are set to the hydrogen evolution reaction (HER) and the hydrogen oxidation reaction (HOR) with a Butler-Volmer relationship between potential and current. At the cathode, the basic version of the HER/HOR is used:

$${H}_{2} O + {e}^{-} \to {OH}^{-} + \frac{1}{2} {H}_{2}$$

At the anode, the acidic version of HER/HOR is used:

$${H}^{+} + {e}^{-} \to \frac{1}{2} {H}_{2}$$

Simulations use transfer coefficients of 0.5 for the Butler-Volmer equation and exchange current densities of 70 mA/cm² and 0.4 mA/cm². To help with convergence, exchange current densities 5000 times lower than the previous values are used and then adjusted the boundary conditions on the simulation's results using the Tafel slope to calculate the extra electrode potential drop required for the intended current density. Because the exchange current density plays a role in the potential values at the boundary, not the interior of the system, when simulated at constant current, the voltage drop at each electrode can be modified by ln

$$5000 \times \frac{RT}{0.5 F}$$

to account for the difference in the exchange current density. Water equilibrium is enforced throughout the cell with K_{w}=10⁻¹⁴. Additionally, the empty volume fraction in the physical separator is set to 0.25. The diffusion coefficients are

$${D}_{{Na}^{+}} = 1.33 \times {10}^{- 9} \frac{{m}^{2}}{s} , {D}_{{H}^{+}} = 6.96 \times {10}^{- 9} \frac{{m}^{2}}{s} , {D}_{{OH}^{-}} = 4.96 \times {10}^{- 9} \frac{{m}^{2}}{s} . , {D}_{{Cl}^{-}} = 2.03 \times {10}^{- 9} \frac{{m}^{2}}{s}$$

and the relative permittivity of water was set to 78.3.

### Example 5: Derivation of Equations 5 and 6

The equilibrium potential for the reaction at the cathode and anode will be:

$${E}_{anode / cathode}^{eq} = 0 V vs . SHE - 60 \frac{mV}{dec} {pH}_{anode / cathode}$$

The overall equilibrium potential for the cell will thus be:

$${V}_{cell}^{eq} = {E}_{cathode}^{eq} - {E}_{anode}^{eq} = 60 \frac{mV}{dec} ( {pH}_{anode} - {pH}_{cathode} ) = 0.06 \vert Δ pH \vert$$

There will also be a kinetic overpotential contribution from each electrode reaction:

Vₒᵥₑᵣₚₒₜₑₙₜᵢₐₗ=η_{cathode}+η_{anode}=η

For simplicity, overpotentials are lumped together into one parameter, η.

Last, there is a resistance drop across the solution. This resistance drop will be equal to:

V_{resistance}=iRₛₒₗᵤₜᵢₒₙ

Where the solution resistance is a function of the geometry, namely the area, A, the width of the cathode and anode compartments, d, and the resistivity of the solution, ρ.

$${V}_{resistance} = i {R}_{solution} = i \frac{2 d ρ}{A}$$

Note that in practice, there will also be a resistance associated with the separator, but it can be assumed that it is smaller than the solution resistance. Overall, Equation 5 can be derived:

$${V}_{c e l l} = {V}_{c e l l}^{e q} + {V}_{overpotential} + {V}_{resistance} = 0.06 \vert Δ pH \vert + η \frac{2 d ρ}{A}$$

To calculate the pH of each compartment (Equation 6), the concentration of protons in solution can be calculated:

$$\\ pH = - {log}_{10} [ {c}_{{H}^{+}} ]$$

$$\\ {c}_{{H}^{+}} = \frac{i}{F} \times \frac{1}{\dot{V}}$$

Here, F is the Faraday constant and \dot{V} is the electrolyte flowrate through each compartment.

### Example 6: Concentration Length Scales

While there are analytical solutions to velocity profiles of flow through parallel plates and mass balances for chemical species in such velocity fields, for understanding the concentration gradients in the system, diffusion scaling is used. Assume the velocity profile is only parallel to the electrode, so that protons or hydroxides produced at the electrodes will move perpendicularly away from the electrode surface via diffusion (due to the large concentration of sodium chloride, migration may be neglected). The scaling for diffusion looks like:

L˜\sqrt{Dt}

Where L is the characteristic diffusion length, D is the diffusion constant, and t is the characteristic time. The diffusion constant for protons is known (see description of COMSOL Multiphysics modelling above), and the characteristic time can be calculated as the volume of the cell compartment, V=d×A (where d is the width of the compartment and A is the electrode area) divided by the flowrate, fᵢₙ:

$$\\ L \sim \sqrt{\frac{DAd}{{f}_{in}}}$$

Using the cell geometry, L≈0.096 mm. This is smaller than the gradients in the COMSOL Multiphysics results (0.5 to 1 mm), but comparable to validate this approach. From this scaling, the effect of how increasing flowrate, cell width, and electrode area can influence the concentration boundary layer and prevent or allow proton crossover can be estimated.

### Example 7: Data

TABLE 1
Raw data from galvanostatic staircase
measurements across multiple trials.

| | | | | Theoretical |
|---|---|---|---|---|
| Trial | Current | Average | V - IR | Minimum |
| # | (mA) | Voltage (V) | (V) | Voltage (V) |
| 1 | 50 | 1.25 | 0.73 | 0.52 |
| 1 | 100 | 1.87 | 0.83 | 0.56 |
| 1 | 150 | 2.43 | 0.88 | 0.58 |
| 1 | 200 | 2.94 | 0.89 | 0.60 |
| 1 | 250 | 3.45 | 0.90 | 0.61 |
| 1 | 300 | 3.93 | 0.89 | 0.62 |
| 1 | 350 | 4.28 | 0.76 | 0.62 |
| 1 | 400 | 4.84 | 0.85 | 0.63 |
| 1 | 450 | 5.26 | 0.80 | 0.64 |
| 1 | 500 | 5.68 | 0.76 | 0.64 |
| 2 | 50 | 1.39 | 0.79 | 0.52 |
| 2 | 100 | 2.05 | 0.86 | 0.56 |
| 2 | 150 | 2.65 | 0.89 | 0.58 |
| 2 | 200 | 3.24 | 0.92 | 0.60 |
| 2 | 250 | 3.83 | 0.96 | 0.61 |
| 2 | 300 | 4.23 | 0.83 | 0.62 |
| 2 | 350 | 4.85 | 0.93 | 0.62 |
| 2 | 400 | 5.26 | 0.84 | 0.63 |
| 2 | 450 | 5.72 | 0.80 | 0.64 |
| 2 | 500 | 6.10 | 0.71 | 0.64 |
| 3 | 50 | 1.29 | 0.73 | 0.52 |
| 3 | 100 | 1.96 | 0.84 | 0.56 |
| 3 | 150 | 2.55 | 0.88 | 0.58 |
| 3 | 200 | 3.15 | 0.93 | 0.60 |
| 3 | 250 | 3.77 | 1.01 | 0.61 |
| 3 | 300 | 4.30 | 1.01 | 0.62 |
| 3 | 350 | 4.76 | 0.93 | 0.62 |
| 3 | 400 | 5.18 | 0.82 | 0.63 |
| 3 | 450 | 5.63 | 0.75 | 0.64 |
| 3 | 500 | 6.20 | 0.80 | 0.64 |

TABLE 2
Raw data for Coulombic efficiency calculations
across multiple trials.

| | | | | | | | | Cou- |
|---|---|---|---|---|---|---|---|---|
| | | | | | Flow- | | | lombic |
| Trial | I | Buffer | Exp. | Exp. | rate | Calc. | Calc. | Effi- |
| # | (mA) | (mM) | [H⁺] | pH | (mL/min) | [H⁺] | pH | ciency |
| 1 | 100 | 1 | 0.008 | 2.110 | 7.333 | 0.008 | 2.072 | 0.915 |
| 1 | 200 | 1 | 0.014 | 1.867 | 8.000 | 0.016 | 1.808 | 0.873 |
| 1 | 300 | 1 | 0.019 | 1.716 | 7.933 | 0.024 | 1.629 | 0.818 |
| 1 | 400 | 1 | 0.023 | 1.641 | 8.000 | 0.031 | 1.507 | 0.735 |
| 1 | 500 | 1 | 0.031 | 1.506 | 8.000 | 0.039 | 1.410 | 0.802 |
| 2 | 100 | 1 | 0.007 | 2.184 | 8.000 | 0.008 | 2.109 | 0.842 |
| 2 | 200 | 1 | 0.013 | 1.874 | 8.000 | 0.016 | 1.808 | 0.861 |
| 2 | 300 | 1 | 0.019 | 1.712 | 8.000 | 0.023 | 1.632 | 0.832 |
| 2 | 400 | 1 | 0.028 | 1.551 | 8.000 | 0.031 | 1.507 | 0.905 |
| 2 | 500 | 1 | 0.035 | 1.456 | 8.000 | 0.039 | 1.410 | 0.900 |
| 3 | 100 | 1 | 0.007 | 2.162 | 8.000 | 0.008 | 2.109 | 0.886 |
| 3 | 200 | 1 | 0.013 | 1.880 | 8.000 | 0.016 | 1.808 | 0.848 |
| 3 | 300 | 1 | 0.019 | 1.725 | 8.000 | 0.023 | 1.632 | 0.808 |
| 3 | 400 | 1 | 0.026 | 1.586 | 8.000 | 0.031 | 1.507 | 0.834 |
| 3 | 500 | 1 | 0.033 | 1.476 | 8.000 | 0.039 | 1.410 | 0.861 |

TABLE 3
Composition of simulated oceanwater, Instant Ocean
Sea salt, which is dissolved in quantities as instructed
by the manufacturer to simulate oceanwater.

| | Instant Ocean synthetic | Natural |
|---|---|---|
| Constituents | oceanwater (mM) | oceanwater (mM) |
| Na⁺ | 416.643 | 480.61 |
| Mg²⁺ | 56.678 | 54.13 |
| Ca²⁺ | 11.766 | 10.52 |
| K⁺ | 9.096 | 10.46 |
| NH₄⁺ | 0.122 | n.a. |
| Li⁺ | 0.09 | n.a. |
| Sr²⁺ | n.a. | 0.092 |
| Cl⁻ | 505.333 | 559.39 |
| SO₄²⁻ | 14.789 | 28.935 |
| HCO₃⁻ | 2.69* | 1.891 |
| CO₃²⁻ | 0.408* | 0.189 |
| CO₂ | 0.0155* | 0.0133 |
| Br⁻ | 1.185 | 0.863 |
| NO₃⁻ | 0.111 | n.a. |
| CH₃COO⁻ | 0.108 | n.a. |
| F⁻ | 0.026 | 0.07 |

*Determined from carbonate alkalinity
n.a. indicates not applicable in this context

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. An electrochemical system comprising:
a cathode with a first side contacting a cathode gas chamber and a second side contacting a catholyte; and
an anode with a first side contacting an anode gas chamber and a second side contacting an anolyte, wherein the catholyte and the anolyte is separated by a separator;
wherein the cathode is configured to catalyze a hydrogen evolution reaction and produce hydrogen gas and a basic stream with a pH less than or equal to 13 and greater than or equal to 7, and the anode is configured to catalyze a hydrogen oxidation reaction and produce an acidic stream with a pH greater than or equal to 1 and less than or equal to 7; and
wherein the cathode gas chamber connects with the anode gas chamber via a flow channel such that the hydrogen gas flows from the anode to the cathode.

2. The electrochemical system of claim 1, wherein the cathode and the anode each comprises a gas diffusion electrode that separates a gas phase and a liquid phase.

3. The electrochemical system of claim 1, wherein the second side of the cathode and the second side of the anode each comprises a layer configured to be a barrier to prevent a gas phase and a liquid phase from mixing; wherein the layer is selected from the group consisting of: a polymer layer, a ceramic layer, a layer with a positive electrical charge, and a layer with a negative electrical charge.

4. The electrochemical system of claim 3, wherein the layer comprises an ionomer selected from the group consisting of a Nafion® ionomer, a Nafion® D520 ionomer, a Sustainion® ionomer, and a Versogen® PiperION-A5 ionomer.

5. The electrochemical system of claim 3, wherein the layer prevents buildup of precipitates on the electrodes when performing polarity switch to the cathode and the anode.

6. The electrochemical system of claim 3, wherein the layer prevents bubble formation on the cathode and the anode.

7. The electrochemical system of claim 1, further comprises current collectors connected to the cathode and the anode for connecting the cathode and the anode to an external circuit.

8. The electrochemical system of claim 1, wherein the catholyte and the anolyte comprise sodium ions and chloride ions.

9. The electrochemical system of claim 1, wherein ionic concentrations of the catholyte and the anolyte are higher than proton and hydroxide ion concentrations such that neutralization of the acidic and basic streams is minimized.

10. The electrochemical system of claim 1, wherein the separator comprises a filter paper, a qualitative grade filter paper, a quantitative grade filter paper, a glass fiber filter, a quartz fiber filter, a chromatography filter paper, a coffee filter paper, a tea filter paper, a ceramic membrane, or a sodium superionic conductor membrane.

11. The electrochemical system of claim 1, wherein the system is configured to achieve a current density less than or equal to 500 mA/cm².

12. The electrochemical system of claim 1, wherein the system has a configuration selected from the group consisting of: an H cell, a cell stack, a flow cell, and a flow stack.

13. The electrochemical system of claim 1, wherein the basic stream has a pH greater than 12 and the acidic stream has a pH less than 2.

14. The electrochemical system of claim 1, wherein the acidic stream and the basic stream are collected for direct carbon capture.

15. The electrochemical system of claim 1, wherein the system has a Coulombic efficiency of at least 80%.

16. A system for direct ocean capture, comprising:
an input configured to receive a source oceanwater;
an electrochemical system configured to receive a first portion of the source oceanwater as an electrolyte;
wherein the electrochemical system comprises:
a cathode with a first side contacting a cathode gas chamber and a second side contacting a catholyte; and
an anode with a first side contacting an anode gas chamber and a second side contacting an anolyte;
wherein the catholyte and the anolyte are configured to receive the electrolyte and are separated by a separator;
wherein the cathode is configured to catalyze a hydrogen evolution reaction and produce hydrogen gas and a basic stream with a pH less than or equal to 13 and greater than or equal to 7, and the anode is configured to catalyze a hydrogen oxidation reaction and produce an acidic stream with a pH greater than or equal to 1 and less than or equal to 7; and
wherein the cathode gas chamber connects with the anode gas chamber via a flow channel such that the hydrogen gas flows from the anode to the cathode;
a carbon dioxide stripping system configured to receive acidified oceanwater comprising a second portion of the source oceanwater and the acidic stream;
wherein the carbon dioxide stripping system is configured to separate gaseous carbon dioxide and produce a decarbonized oceanwater stream;
wherein the decarbonized oceanwater stream is configured to combine with the basic stream before being returned to the ocean.

17. The system of claim 16, wherein the cathode and the anode each comprise a gas diffusion electrode that separates a gas phase and a liquid phase.

18. The system of claim 16, wherein the second side of the cathode and the second side of the anode each comprises a layer configured to be a barrier to prevent a gas phase and a liquid phase from mixing; wherein the layer is selected from the group consisting of: a polymer layer, a ceramic layer, a layer with a positive electrical charge, and a layer with a negative electrical charge.

19. The system of claim 18, wherein the layer comprises an ionomer selected from the group consisting of a Nafion® ionomer, a Nafion® D520 ionomer, a Sustainion® ionomer, and a Versogen® PiperION-A5 ionomer.

20. The electrochemical system of claim 18, wherein the layer prevents buildup of precipitates on the electrodes when performing polarity switch to the cathode and the anode.

21. The electrochemical system of claim 18, wherein the layer prevents bubble formation on the cathode and the anode.

22. The system of claim 16, wherein the electrochemical system further comprises current collectors connected to the cathode and the anode for connecting the cathode and the anode to an external circuit.

23. The system of claim 16, wherein an ionic concentration of the electrolyte is higher than proton and hydroxide ion concentrations such that neutralization of the acidic and basic streams is minimized.

24. The system of claim 16, wherein the separator comprises a filter paper, a qualitative grade filter paper, a quantitative grade filter paper, a glass fiber filter, a quartz fiber filter, a chromatography filter paper, a coffee filter paper, a tea filter paper, a ceramic membrane, or a sodium superionic conductor membrane.

25. The system of claim 16, wherein the electrochemical system is configured to achieve a current density less than or equal to 500 mA/cm².

26. The system of claim 16, wherein the electrochemical system has a configuration selected from the group consisting of: an H cell, a cell stack, a flow cell, and a flow stack.

27. The system of claim 16, wherein the basic stream has a pH greater than 12 and the acidic stream has a pH less than 2.

28. The system of claim 16, wherein the electrochemical system has a coulombic efficiency of at least 80%.

29. A method for generating acidic and basic streams, comprising:
applying a voltage to a cathode and an anode; and
wherein a first side of the cathode connects with a cathode gas chamber, and a second side of the cathode connects with a catholyte; wherein the cathode is configured to catalyze a hydrogen evolution reaction and produce hydrogen gas and a basic stream with a pH less than or equal to 13 and greater than or equal to 7;
wherein a first side of the anode connects with an anode gas chamber, and a second side of the anode connects with an anolyte; wherein the anode is configured to catalyze a hydrogen oxidation reaction and produce an acidic stream with a pH greater than or equal to 1 and less than or equal to 7;
wherein the catholyte and the anolyte are separated by a separator; and
wherein the cathode gas chamber connects with the anode gas chamber via a flow channel such that the hydrogen gas flows from the anode to the cathode;
collecting the acidic stream and the basic stream.

30. The method of claim 29, wherein the cathode and the anode each comprises a gas diffusion electrode that separates a gas phase and a liquid phase.

31. The method of claim 29, wherein the second side of the cathode and the second side of the anode each comprises a layer configured to be a barrier to prevent a gas phase and a liquid phase from mixing; wherein the layer is selected from the group consisting of: a polymer layer, a ceramic layer, a layer with a positive electrical charge, and a layer with a negative electrical charge.

32. The method of claim 31, wherein the layer comprises an ionomer selected from the group consisting of a Nafion® ionomer, a Nafion® D520 ionomer, a Sustainion® ionomer, and a Versogen® PiperION-A5 ionomer.

33. The electrochemical system of claim 31, wherein the layer prevents bubble formation on the cathode and the anode.

34. The method of claim 29, wherein the catholyte and the anolyte comprise sodium ions and chloride ions.

35. The method of claim 29, wherein ionic concentrations of the catholyte and the anolyte are higher than proton and hydroxide ion concentrations such that neutralization of the acidic and basic streams is minimized.

36. The method of claim 29, wherein the separator comprises a filter paper, a qualitative grade filter paper, a quantitative grade filter paper, a glass fiber filter, a quartz fiber filter, a chromatography filter paper, a coffee filter paper, a tea filter paper, a ceramic membrane, or a sodium superionic conductor membrane.

37. The method of claim 29, wherein the basic stream has a pH greater than 12 and the acidic stream has a pH less than 2.

38. The method of claim 29, wherein the acidic stream and the basic stream are collected for direct carbon capture.

39. The method of claim 29, further comprising switching a polarity of the voltage at a frequency to prevent buildup of precipitates on the cathode and the anode.
